(19) United States
(12) Patent Application Publication
(10) Pub. No.: US 2024/0050209 A1
(43) Pub. Date: Feb. 15, 2024

(54) ORAL IRRIGATION

(71) Applicant: QUIP NYC INC., Brooklyn, NY (US)

(72) Inventors: Jonathan Henry FRATTI, Brooklyn, NY (US); Eric Glenn HARSH, Brooklyn, NY (US); Steffany V. TRAN, New York, NY (US); Nathan A. HERRMANN, New York, NY (US); Simon J. M. ENEVER, Brooklyn, NY (US); William MAY, Purcellville, VA (US); Sean James WILSON, Hoboken, NJ (US); James C. KRAUSE, Long Island City, NY (US); Maxwell R. WOOD-LEE, Brooklyn, NY (US); Paul B. KOH, New York, NY (US); Jonathan Pradeep AUSTIN, Johns Creek, GA (US)

(21) Appl. No.: 18/449,637

(22) Filed: Aug. 14, 2023

Related U.S. Application Data
(60) Provisional application No. 63/397,727, filed on Aug. 12, 2022.
(60) Provisional application No. 63/398,188, filed on Aug. 15, 2022.

(51) Int. Cl. A61C 17/02

(52) U.S. Cl. CPC A61C 17/0202

(57) ABSTRACT

Devices, systems, and methods of the present disclosure are generally directed to facilitating user control of high-pressure flow of liquid for oral irrigation carried out as part of personal dental care. Such control over high-pressure flow may reduce the likelihood of errant spray of liquid outside of the user's mouth (e.g., onto mirrors, countertop surfaces, or the user's clothes). Such improved control over errant spraying may reduce the potential for frustration and, thus, may promote maintaining oral irrigation as part of a personal dental care routine. Further, or instead, through facilitating user control of high-pressure flow of liquid, the devices, systems, and methods of the present disclosure may improve the effectiveness and efficiency of self-administered oral irrigation in promoting a user's oral hygiene.

### CROSS-REFERENCE TO RELATED APPLICATIONS

This application claims the benefit of priority to U.S. Provisional Patent Application No. 63/397,727, filed on Aug. 12, 2022, and to U.S. Provisional Patent Application No. 63/398,188, filed on Aug. 15, 2022, with the entire contents of each of these applications incorporated herein by reference.

### BACKGROUND

Oral irrigation is a dental hygiene procedure that includes directing a high-pressure flow of liquid, such as water, to interdental spaces and below the gum line to remove plaque, toxins, and debris that can lead to conditions such as tooth decay and gum disease. This procedure can be carried out by a user as part of a routine for preventive oral care. That is, a user can operate an oral irrigation device in an at-home setting to carry out an oral irrigation treatment in the user's mouth, much like users typically carry out brushing and flossing on themselves as part of daily dental care.

While the use of an oral irrigation device in an at-home setting is convenient and may offer potential benefits to oral health, it can be difficult for a user to control the high-pressure flow of liquid as the user attempts to carry out an oral irrigation procedure on the user's own mouth. For example, as the user moves the oral irrigation device, the high-pressure flow of liquid may be errantly directed outside of the user's mouth and/or to an unintended portion of the user's mouth. Accordingly, there remains a need for controlling oral irrigation for personal dental care.

### SUMMARY

Devices, systems, and methods of the present disclosure are generally directed to facilitating user control of high-pressure flow of liquid for oral irrigation carried out as part of personal dental care. Such control over high-pressure flow may reduce the likelihood of errant spray of liquid outside of the user's mouth (e.g., onto mirrors, countertop surfaces, or the user's clothes). Such improved control over errant spraying may reduce the potential for frustration and, thus, may promote maintaining oral irrigation as part of a personal dental care routine. Further, or instead, through facilitating user control of high-pressure flow of liquid, the devices, systems, and methods of the present disclosure may improve the effectiveness and efficiency of self-administered oral irrigation in promoting a user's oral hygiene.

According to an aspect, an oral irrigation device comprising a battery, a motor in electrical communication with the battery, a pump mechanically coupled to the motor, a nozzle insertable into a mouth of a user, a housing defining a reservoir, the housing carrying the motor, the pump, the battery, and the nozzle, the nozzle extending in a direction away from the housing, the nozzle in fluid communication with the reservoir via the pump, and an actuator carried on the housing, the actuator in electrical communication with the battery and the motor, the actuator selectively switchable between momentary switch operation and latching switch operation in delivering energy from the battery to the pump via the motor.

In certain implementations, the actuator is selectively switchable between momentary switch operation and latching switch operation in response to manual input to the actuator. For example, the actuator may be partially depressible to switch the actuator to momentary switch operation, and the actuator may be fully depressible to switch the actuator to latching switch operation.

In some implementations, energy from the battery may be delivered to the pump, via the motor, for a period corresponding to a duration of a manual input to the actuator in momentary switch operation.

In certain implementations, energy from the battery may be delivered to the pump, via the motor, continuously until a manual input to the actuator in latching switch operation.

In some implementations, energy from the battery may be delivered to the pump, via the motor, until a predetermined motor operation time limit is met in momentary switch operation, latching switch operation, or a combination thereof.

In certain implementations, the housing may be elongate and manually graspable by the user. In some instances, the actuator may be supported on the housing in a position accessible for single-handed operation by the user grasping the housing.

In some implementations, the housing may define a cavity, and the motor, the pump, and the battery are disposed in the cavity with the motor with the battery fluidically isolated from the reservoir. The reservoir and the cavity have about the same volume in some instances. Further, or instead, the housing may be formed of a first material along at least a portion of the reservoir, the housing may be formed of a second material along at least a portion of the cavity, and the first material is secured to the second material along an ultrasonic weld. In some instances, the first material may be different from the second material. Additionally, or alternatively, the first material may allow transmission of visible light, and the second material is opaque. In some instances, the actuator may include a first section and a second section mechanically coupled to one another, the housing includes a plurality of struts and a hub, the plurality of struts supporting the hub along the cavity, the actuator supported on the hub with the first section of the actuator extending through the hub and into the cavity, and the plurality of struts are flexible in response to pressure on the second section of the actuator in a direction into the cavity to selectively switch between momentary switch operation and latching switch operation. Further, or instead, the housing may include a membrane extending between the plurality of struts and circumscribing the hub. As an example, the membrane, the hub, and the first section of the actuator may collectively form a seal fluidically isolating the second section of the actuator from the cavity. In some instances, the membrane may be overmolded on the plurality of struts and around the hub. Additionally, or alternatively, the membrane may be formed of thermoplastic elastomer (TPE) and the plurality of struts are formed of acrylonitrile butadiene styrene (ABS). In certain instances, the second section of the actuator may be securable to the first section of the actuator while the first section of the actuator forms a portion of the seal. Further, or instead, the first section of the actuator and the second section of the actuator may be adhesively coupled to one another. In some instances, the oral irrigation device may further include a shell disposed over at least a portion of the membrane, wherein the shell defines an orifice, and the second section of the actuator is substantially centered in the orifice of the shell. The shell may be adhesively secured to the housing. Additionally, or alternatively, the shell is anodized aluminum. In certain instances, the first section of the actuator may be positionable into the cavity, via the hub, with the motor and the pump disposed in the cavity.

In certain implementations, the oral irrigation device may further include a permanent magnet and a collar, wherein the permanent magnet is carried by the housing, the collar is supported on the nozzle, the collar includes at least one ferromagnetic material, and the nozzle is releasably securable to the housing through magnetic force between the permanent magnet and the at least one ferromagnetic material of the collar. In some instances, the permanent magnet may be fixed to the housing, the collar is fixed to the nozzle, and the nozzle is rotatable relative to the housing with the nozzle releasably secured to the housing. As an example, the collar may be positionable in face-to-face contact with the permanent magnet to releasably secure the nozzle to the housing. Additionally, or alternatively, the oral irrigation device may further include a sleeve disposed between the nozzle and the housing with the nozzle releasably secured to the housing, wherein the sleeve includes rubber.

In some implementations, the oral irrigation device may further include a lid rotatably supported on the housing, wherein the lid is movable between an open position and a closed position to provide access to the reservoir, and the lid in the closed position forms a seal along a circumference of the reservoir.

According to another aspect, a nozzle for an oral irrigation device, the nozzle including a body including a first end portion and a second end portion, the first end portion of the body positionable in a housing of the oral irrigation device with the body releasably secured to the housing of the oral irrigation device and with the second end portion of the body supported away from the housing of the oral irrigation device, and a filter disposed in fluid communication with the second end portion of the body.

In certain implementations, the first end portion of the body may define a first orifice having a first diameter, the second end portion of the body defines a second orifice having a second diameter less than the first diameter, and the filter is supported along the first end portion of the body.

According to yet another aspect, a method of controlling an oral irrigation device may include receiving at least one signal from a motor mechanically coupled to a pump, the at least one signal indicative of force of a liquid on a nozzle in fluid communication with the pump and insertable into the mouth of a user, based on comparison of the at least one signal to a predetermined threshold indicative of unobstructed operation of the nozzle in fluid communication with the pump, detecting a dislodgment risk condition of the nozzle, operating the motor when the dislodgment risk condition is not detected, and initiating a remedial action associated with operation of the motor when the dislodgment risk condition is detected.

In some implementations, the at least one signal from the motor may include one or more of the following parameters of the motor in operation: voltage, current, impedance, speed, power, or torque.

In certain implementations, the remedial action may include shutting off the motor. In some implementations, the remedial action may include providing an alert to the user.

In certain implementations, the method may further include receiving an operation mode of the motor based on a manual input from a user, wherein operating the motor includes operating the motor according to the operation mode, and the operation mode of the motor is one of normally-on or normally-off.

According to still another aspect, a controller for an oral irrigation device may include one or more processors; and a memory including at least one non-transitory computer-readable storage medium communicatively coupled to the one or more processors, the at least one non-transitory computer-readable storage medium having stored thereon instructions for causing the one or more processors to carry out any one or more of the various different methods described herein.

According to still another aspect, a dental care system may include an oral hygiene device including a battery, a motor, a first contact, a second contact, and a housing, the battery and the motor each disposed in the housing, and the first contact and the second contact each carried on the housing and each in electrical communication with the motor via the battery, and a charger including a first connector and a second connector, the first connector including a pin and a ring, the ring having a nonplanar surface, the oral hygiene device having a stable orientation on a flat surface with the pin of the first connector touching the first contact and the ring touching the second contact, and the second connector connectable to a power source to charge the battery of the oral hygiene device supported in the stable orientation on the first connector.

In certain implementations, the housing of the oral hygiene device may be manually graspable in single-handed operation by a user.

In some implementations, the housing of the oral hygiene device may define a recess, and the first connector of the charger is releasably positionable in the recess to position the pin into contact with the first contact and the ring into contact with the second contact.

In certain implementations, the housing of the oral hygiene device may be elongate, and the oral hygiene device is supportable in the stable orientation on the first connector with the housing extending lengthwise in a direction away from the first connector. In some instances, the oral hygiene device may include a dental implement (e.g., a nozzle) supported on the housing and, with the oral hygiene device supported in the stable orientation on the first connector, the dental implement is spaced away from the first connector by the length of the housing.

In some implementations, the nonplanar surface of the ring may circumscribe the pin.

In certain implementations, the nonplanar surface of the ring may be continuous.

In some implementations, the nonplanar surface of the ring may define a volume, at least a portion of the pin extends in the volume, and a portion of the housing of oral hygiene device is positionable into the volume to contact the first contact and the second contact to the pin and the ring, respectively.

In certain implementations, the pin of the first connector and the first contact of the oral hygiene device may be connectable to one another with an interference fit.

In some implementations, the ring of the first connector and the second contact of the oral hygiene device may be magnetically connectable to one another.

In certain implementations, the first connector may include a cover having a flat surface, and the pin and the ring are oriented away from the flat surface.

In some implementations, the charger may include a fuse in electrical communication between the first connector and the second connector. The fuse may be, for example, a polymeric positive temperature coefficient fuse.

According to still another aspect, a charger may include a first connector and a second connector, the first connector including a pin and a ring, the oral hygiene device supportable in a stable orientation on the first connector with the pin touching a first contact of the oral hygiene device and the nonplanar surface touching a second contact of the oral hygiene device, a second connector connectable to a power source to charge a battery of the oral hygiene device connected in electrical communication with the pin and ring of the first connector, and a polymeric positive temperature coefficient fuse, the pin and the ring of the first connector in electrical communication with the second connector via the polymeric positive temperature coefficient fuse.

In certain implementations, the ring may have a nonplanar surface.

In some implementations, the second connector may be a USB connector.

### BRIEF DESCRIPTION OF THE DRAWINGS

FIG. 1 is a top rear perspective view of a dental care system including an oral irrigation device and a charger.

FIG. 2A is a top front perspective view of the oral irrigation device of FIG. 1.

FIG. 2B is a left-side view of the oral irrigation device of FIG. 1.

FIG. 2C is a right-side view of the oral irrigation device of FIG. 1.

FIG. 2D is a front view of the oral irrigation device of FIG. 1.

FIG. 2E is a rear view of the oral irrigation device of FIG. 1.

FIG. 2F is a top view of the oral irrigation device of FIG. 1.

FIG. 2G is a bottom view of the oral irrigation device of FIG. 1.

FIG. 2H is a bottom rear perspective view of the oral irrigation device of FIG. 1.

FIG. 2I is a perspective right-side view of a cross-section of the oral irrigation device of FIG. 1, the cross-section taken along 21-21 in FIG. 2H.

FIG. 2J is a right-side view of the cross-section of the oral irrigation device shown in FIG. 2I.

FIG. 2K is a close-up side view of the area of detail 2K of the cross-section of the oral irrigation device shown in FIG. 2J.

FIG. 2L is a right-side view of the cross-section of the oral irrigation device shown in FIG. 2J, shown with a nozzle of the oral irrigation device removed from a housing of the oral irrigation device.

FIG. 2M is a top view of a cross-section of the oral irrigation device of FIG. 1, the cross-section taken along 2M-2M in FIG. 2A.

FIG. 2N is a bottom side perspective view of the oral irrigation device of FIG. 1, with a shell, a membrane, and a portion of a housing of the oral irrigation device shown in exploded view.

FIG. 2O is a left side view of the oral irrigation device of FIG. 1, shown with the shell, the membrane, a portion of the housing of the oral irrigation device, and an electronics casing removed.

FIG. 2P is a perspective view of a portion of the housing shown exploded from a membrane and actuators of the oral irrigation device of FIG. 1.

FIG. 3A is a side view of a charger of FIG. 1.

FIG. 3B is a side view of a cross-section of the charger of FIG. 1, with the cross-section taken along 3B-3B in FIG. 1.

FIG. 3C is a top view of the charger of FIG. 1.

FIG. 3D is a bottom view of the charger of FIG. 1.

FIG. 3E is a front view of the charger of FIG. 1.

FIG. 4 is a flow chart of an exemplary method of controlling an oral irrigation device.

Like reference symbols in the various drawings indicate like elements.

### DETAILED DESCRIPTION

Embodiments will now be described more fully hereinafter with reference to the accompanying figures, in which exemplary embodiments are shown. The foregoing may, however, be embodied in many different forms and should not be construed as limited to the exemplary embodiments set forth herein. All fluid flows may flow through conduits (e.g., pipes and/or manifolds) unless specified otherwise.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

In the description that follows, devices, systems, and methods are generally described in the context of oral irrigation for the sake of clear and efficient description of various features. Unless otherwise specified or made clear from the context, it should be more generally understood that devices, systems, and methods described herein may be used in the context of other types of oral hygiene devices. Thus, for example, unless a contrary intent is explicitly set forth, the devices, systems, and methods described herein may be used in the context of electric toothbrushes. As a specific example, the various different aspects of charging described herein may be used in the context of an oral hygiene device including a toothbrush head that is driven by an electric motor.

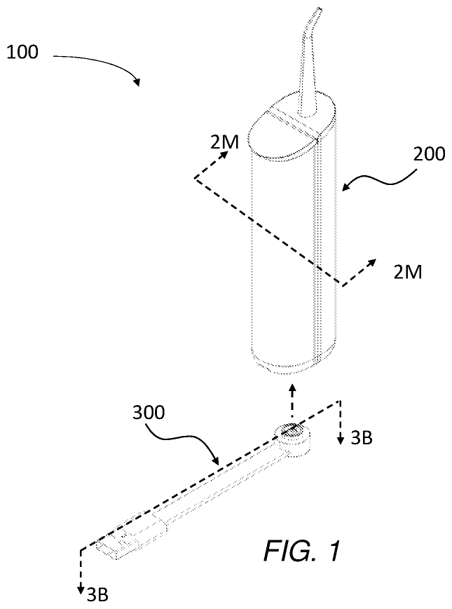

Referring now to FIG. 1, a dental care system 100 may include an oral irrigation device 200 and a charger 300. The charger 300 may include a first connector 302 and a second connector 304. The oral irrigation device 200 may be supportable in a stable orientation on the first connector 302, as described in greater detail below. Further, or instead, the second connector 304 of the charger 300 may be connectable to a power source (e.g., a power outlet) to charge a battery of the oral irrigation device 200 supported in the stable orientation on the first connector 302.

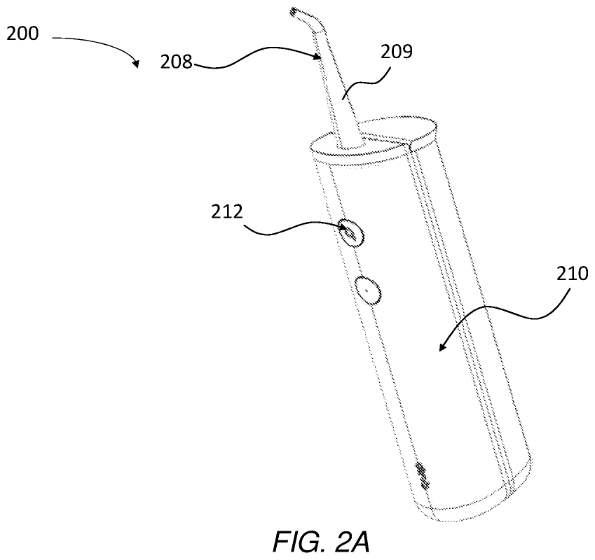

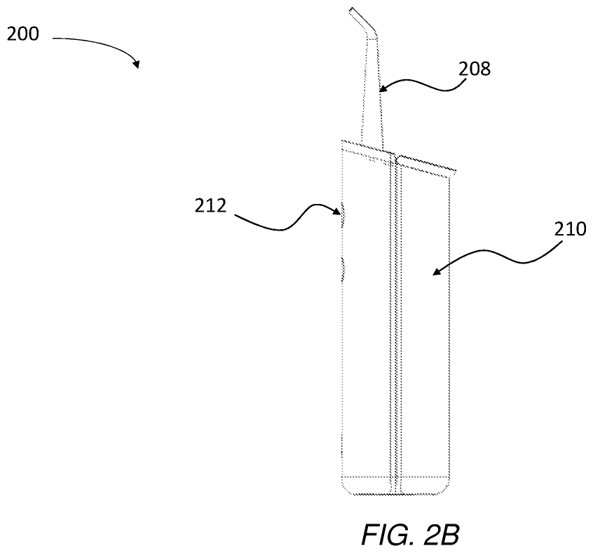

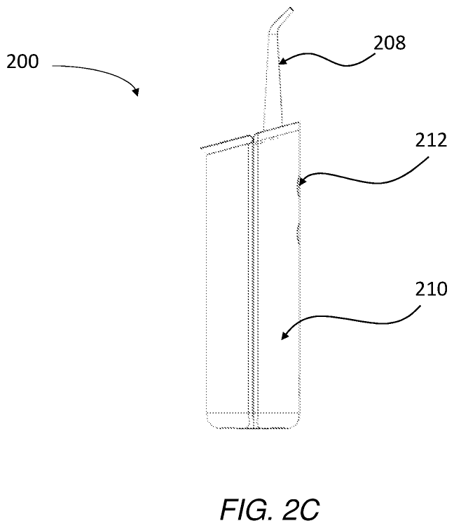

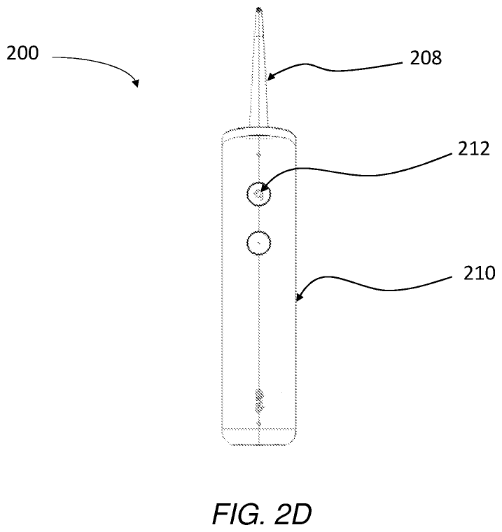

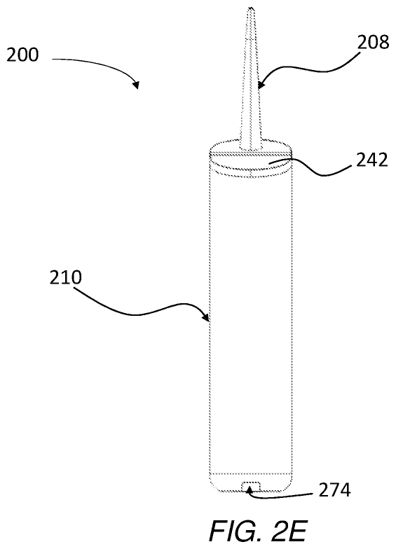

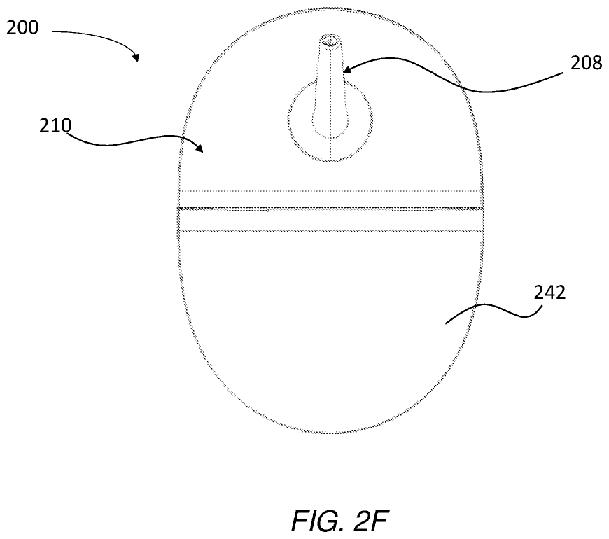

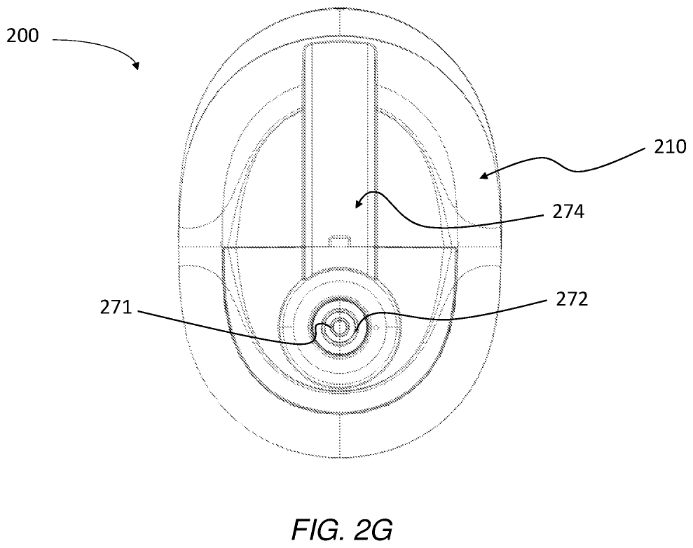

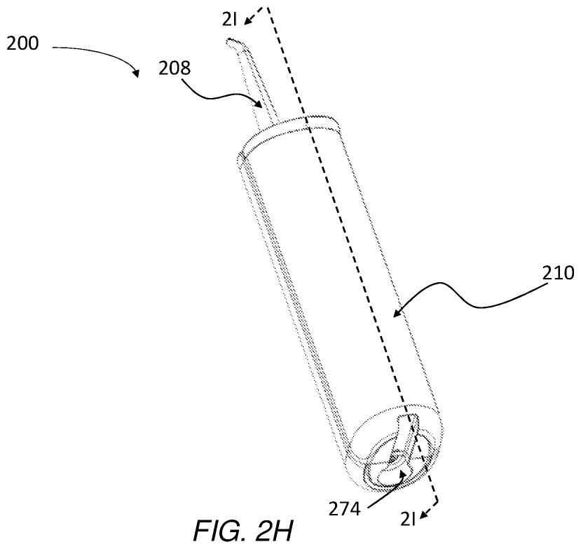

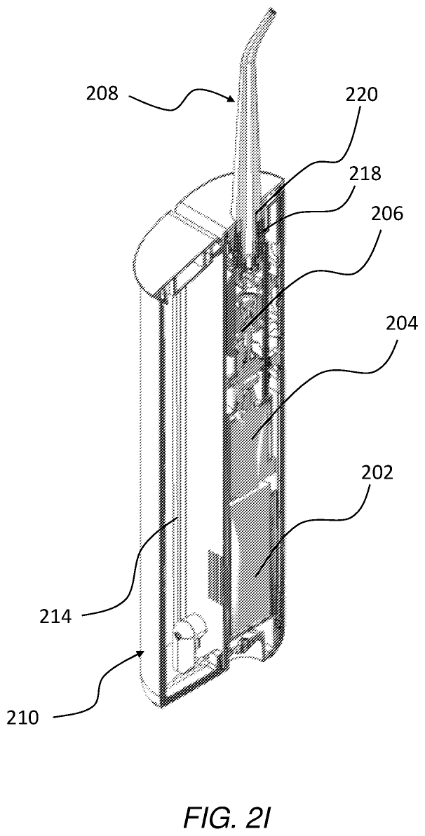

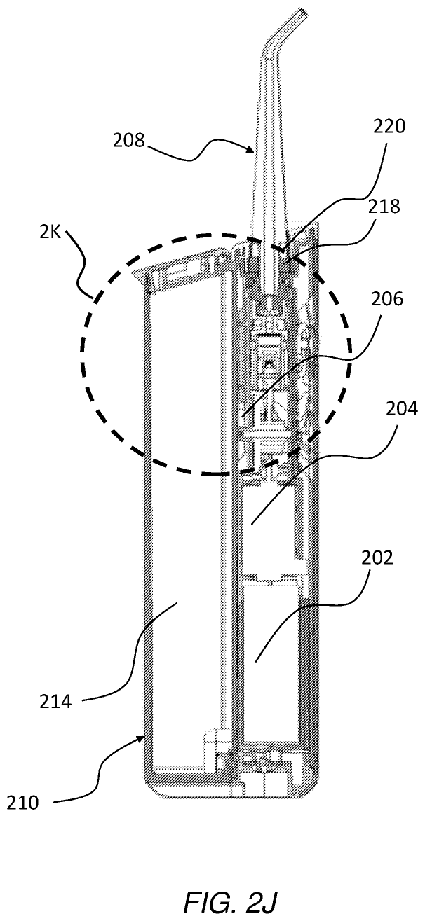

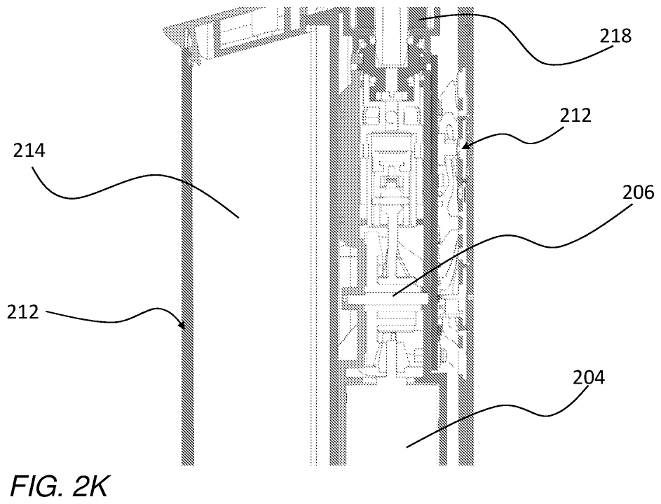

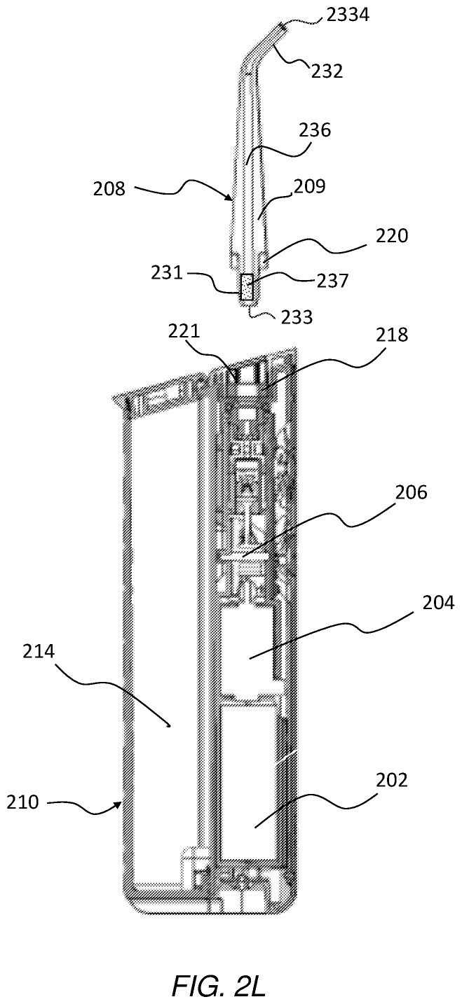

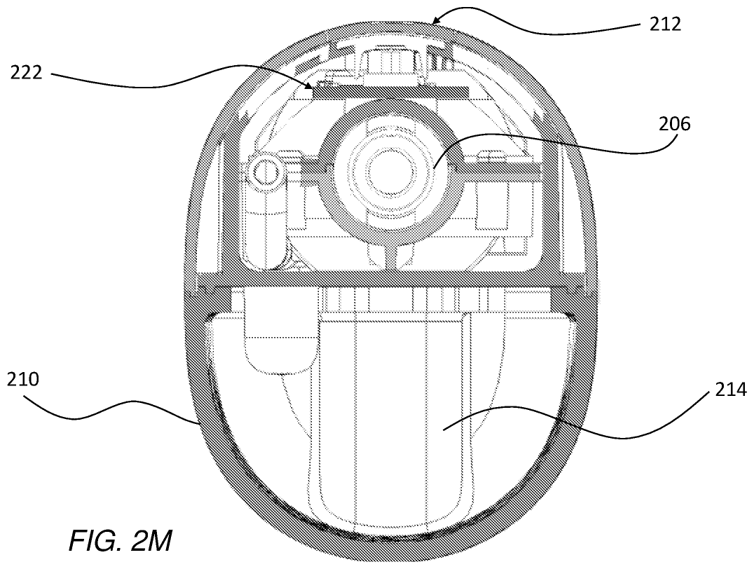

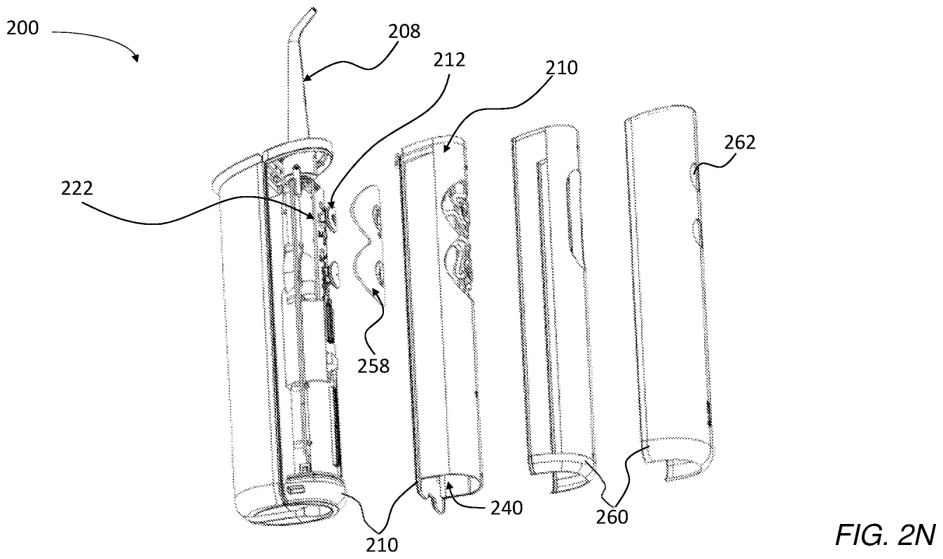

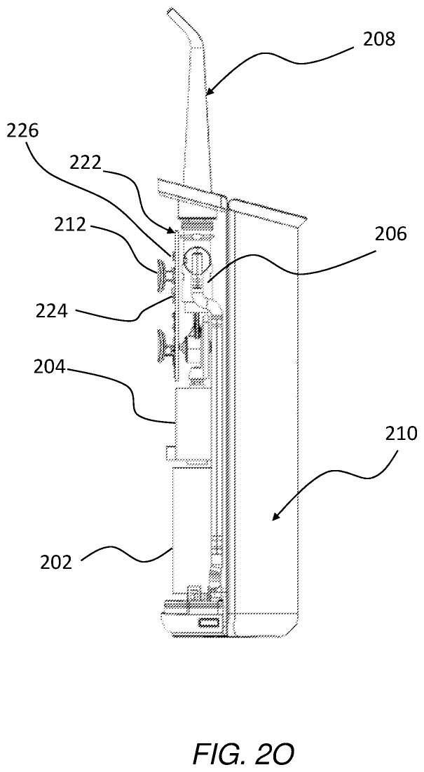

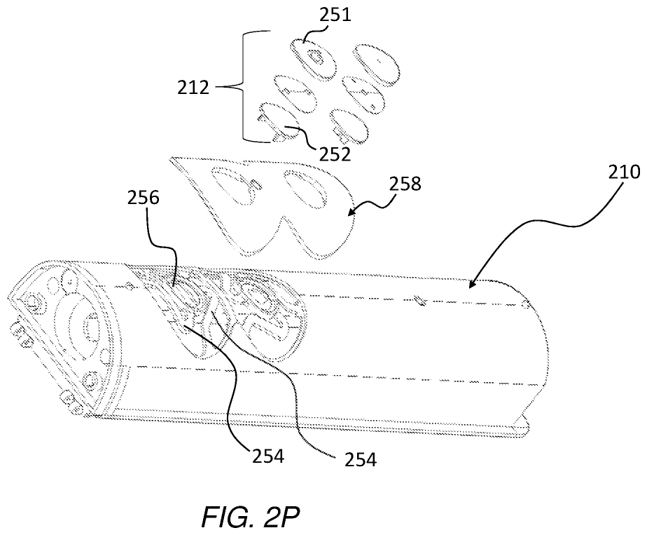

Referring now to FIGS. 2A-2P, the oral irrigation device 200 may include a battery 202, a motor 204, a pump 206, a nozzle 208, a housing 210, and an actuator 212. The housing 210 may define a reservoir 214, and the housing 210 may carry the motor 204, the pump 206, the battery 202, and the nozzle 208. For example, the nozzle 208 may extend in a direction away from the housing 210, and the nozzle 208 may be in fluid communication with the reservoir 214 via the pump 206. The motor 204 may be an electric motor in electrical communication with the battery 202, and the pump 206 may be mechanically coupled to the motor 204 such that electrical energy stored in the battery 202 may be converted into mechanical energy by the motor 204. In turn, the mechanical energy provided by the motor 204 may drive the pump 206 to move a liquid from the reservoir 214. As a specific example, the liquid moving from the reservoir 214 through operation of the pump 206 may move through the nozzle 208 as a high-pressure stream (e.g., a pulsated stream) of fluid during use of the oral irrigation device 200 as part of an oral irrigation procedure self-administered by a user. As described in greater detail below, the oral irrigation device 200 may additionally or alternatively include an actuator 212 carried on the housing and in electrical communication with the battery 202 and the motor 204. As also described in greater detail below, the housing 210 may be manually graspable in single-handed operation by a user (e.g., with a grip that allows the user to grasp the housing 210 while actuating the actuator 212 as the user carries out a self-administered oral irrigation treatment).

In general, the nozzle 208 may be any one or more of any different shapes insertable into the mouth of a user to deliver one or more liquids as part of an oral hygiene treatment. Further, or instead, the nozzle 208 may be sized such that, within the user's mouth, the nozzle 208 may be movable to direct a high-pressure stream of liquid to any portion of the user's teeth and/or gums. For example, the fluid may be water or a cleaning solution (e.g., mouthwash in regular or diluted concentration), and the fluid may be delivered in the high-pressure stream from the nozzle 208 to the user's teeth and/or gums to dislodge food particles or other material as part of an oral irrigation treatment.

In certain implementations, the nozzle 208 may be releasably securable to the housing 210 and in fluid communication with the pump 206 through magnetic force. For example, the oral irrigation device 200 may include a permanent magnet 218 and a collar 220. The permanent magnet 218 may be carried by the housing 210, and the collar 220 may be supported on the nozzle 208. The collar 220 may include at least one ferromagnetic material such that bringing the collar 220 into proximity with the permanent magnet 218 carried by the housing 210 holds the nozzle 208 in place relative to the housing 210 in at least an axial direction of the high-pressure flow of liquid pumped through the nozzle 208 and into the mouth of the user.

As an example, the permanent magnet 218 may be fixed to the housing 210, and the collar 220 may be fixed to the nozzle 208 to facilitate releasably securing the nozzle 208 to the housing 210 using only the uncomplicated motion of pushing the collar 220 into the housing 210 such that the collar 220 moves into proximity of the permanent magnet 218 within the housing 210. Further, or instead, the nozzle 208 may be rotatable relative to the housing 210 with the nozzle 208 releasably secured to the housing 210. That is, with the collar 220 in proximity to the permanent magnet 218 such that the collar 220 and the permanent magnet 218 are magnetically coupled to one another, movement of the nozzle 208 away from the permanent magnet 218 may be limited in an axial direction to maintain fluid communication between the nozzle 208 and the high-pressure fluid being delivered by the pump 206 while the nozzle 208 is rotatable relative to the housing 210 to facilitate directing the high-pressure stream from the nozzle 208 to any one or more portions of the user's mouth during an oral irrigation treatment.

The collar 220 may be positionable in face-to-face contact with the permanent magnet 218 in some implementations to facilitate achieving efficient use of magnetic force to restrict movement of the collar 220 against the force of the high-pressure fluid moving from the pump 206 into the nozzle 208. However, given the nature of magnetic force, it shall be appreciated that such direct face-to-face contact between the collar 220 and the permanent magnet 218 is not necessarily required. That is, for example, the housing 210 may include one or more polymeric surfaces holding the permanent magnet 218 in place and such surfaces may form at least a portion of a landing for the collar 220 when the nozzle 208 is releasably secured to the housing 210. Such indirect coupling may, for example, limit the repeated force on the permanent magnet 218 (e.g., reducing the likelihood of the permanent magnet 218 becoming dislodged) as the nozzle 208 is repeatedly removed and replaced in the housing 210.

Further, or instead, friction between the collar 220 and the permanent magnet 218 to augment the magnetic force that holds the collar 220 and the permanent magnet 218 in place relative to one another such that the nozzle 208 is releasably secured to the housing 210. For example, with the permanent magnet 218 and the collar 220 magnetically coupled to one another, at least a portion of the nozzle 208 and the permanent magnet 218 may form an interference fit with one another. Such an interference fit may facilitate releasably securing the nozzle 208 to the housing 210 with sufficient force to resist axial movement of the nozzle 208 in a direction away from the housing 210 as high-pressure fluid moves through the nozzle 208 while also being releasable from the housing 210 through deliberate axial force applicable by a user, without the need for any special tools. In certain instances, with the nozzle 208 releasably secured to the housing 210, a sleeve 221 may be disposed between the nozzle 208 and the housing 210 such that the sleeve 221 acts as a friction element limiting axial movement of the nozzle 208 in a direction away from the housing 210. As an example, the sleeve 221 may include rubber, which is inexpensive, safe, and robust while also having a high-coefficient of friction with most materials.

In some implementations, the nozzle 208 may include a body 209 having a first end portion 231 and a second end portion 232. The first end portion 231 may define a first orifice 233, the second end portion 232 may define a second orifice 234, and the body may define a lumen 236 extending from the first orifice 233 to the second orifice 234. The first end portion 231 of the body 209 may be positionable in the housing 210 with the nozzle 208 releasably secured to the housing 210 of the oral irrigation 200 (e.g., with the collar 220 supported along the second end portion 232 of the body 209 for magnetic coupling according to any one or more of the various different techniques described herein). With the first end portion 231 of the body 209 positioned in the housing, the second end portion 232 of the body 209 may be supported away from the housing 210 such that the housing 210 is less likely to interfere with movement of the second end portion 232 of the body 209 of the nozzle 208 within the user's mouth during the course of an oral irrigation treatment.

The body 209 of the nozzle 208 may generally have any one or more of various different shapes as may be useful for delivering a high-pressure stream from the nozzle 208 to the user's mouth. As an example, the first orifice 233 may have a first diameter, and the second orifice 234 may have a second diameter less than the first diameter such that pressure of fluid pumped from the reservoir 214 builds within the lumen 236 such that, at the smaller second orifice 234 defined by the second end portion 232 of the body 209, the fluid forms the high-pressure stream directable into the user's mouth. As a specific example, the shape of the lumen 236 may taper in a direction from the first orifice 233 to the second orifice 234. This may be useful for forming a gradual pressure gradient within the lumen 236 which, as compared to a sharp pressure gradient, may reduce the likelihood of unintended disconnection of the first end portion 231 of the nozzle 208 (popping off) from the housing 210 as the high-pressure stream is delivered from the second orifice 234 of the nozzle 208.

In certain implementations, the oral irrigation device 200 may include a filter 237 (e.g., a woven or nonwoven mesh) in fluid communication with the second end portion 232 of the body 209 of the nozzle 208. More specifically, the filter 237 may be disposed between the reservoir 214 and the second end portion 232 of the body 209 of the nozzle 208. Such placement of the filter 237 may be useful for, among other things, for reducing the likelihood of debris exiting the reservoir 214 and accumulating in the body 209 of the nozzle 208 to cause unintended pressure build-up in the oral irrigation device 200. In certain implementations, the filter 237 may be supported on the body 209 of the nozzle 208 to facilitate periodically cleaning or replacing the filter 237 as part of routine maintenance of the oral irrigation device 200. As an example, the filter may be disposed along the first end portion 231 of the nozzle 208 to reduce the likelihood of accumulating debris within the lumen 236 of the body 209. In particular, returning to the example in which the first diameter of the first orifice 233 is greater than the second diameter of the second orifice 234, placing the filter along the first end portion 231 of the nozzle 208 may facilitate forming the filter 237 with a large surface area for collecting debris and additionally, or alternatively, may facilitate inspecting condition of the filter 237 and/or removing the filter 237 from the body 209 for cleaning or replacing the filter 237.

In general, the actuator 212 may be selectively switchable between momentary switch operation and latching switch operation in delivering energy from the battery 202 to the pump 206 via the motor 204. As compared to actuation of an actuator in only one mode of operation, selectively switching the actuator 212 between momentary switch operation and latching switch operation may provide a user with improved control over the high-pressure stream of fluid. For example, the actuator 212 actuated for momentary switch operation may facilitate providing short bursts of the high-pressure stream of fluid to a user's mouth, as may be useful for targeting certain areas and/or for beginning or ending an oral irrigation procedure. Further, or instead, the actuator 212 actuated for latching switch operation may provide longer bursts of the high-pressure stream of fluid to the user's mouth, as may be useful for reducing strain on the user's hand when it is desirable to deliver the high-pressure stream of fluid to the user's mouth for an extended period.

The actuator 212, in some instances, may be selectively switchable between momentary switch operation and latching switch operation in response to one or more manual inputs to the actuator 212. For example, the user may grasp the housing 210 to position the nozzle 208 in or near the user's mouth and, while grasping the housing 210, the user may manually actuate the actuator 212 using one or more fingers of the hand grasping the housing 210. That is, the actuator 212 may be supported on the housing 210 in a position accessible for manual actuation by the same hand grasping the housing 210. In some instances, housing 210 may be elongate while being manually graspable by the user, as may be further or alternatively useful for facilitating single-handed operation of the oral irrigation device 200 by the user. As an example, the housing 210 have a short dimension manually graspable by the user while the elongate dimension of the housing 210 may be sized to accommodate various components while also providing for storage capacity of the reservoir 214 to carry out at least a single oral irrigation treatment.

In certain implementations, actuator 212 may be actuatable such that the same manual input motion is used for switching between momentary switch operation and latching switch. For example, the actuator 212 may be partially depressible to switch the actuator 212 to momentary switch operation and the actuator may be fully depressible to switch the actuator 212 to latching switch operation. Stated differently, the user may use the same motion on the actuator 212—while varying only depth of the motion—to control whether a high-pressure stream issuing from the nozzle 208 is manually pulsed by the user or is continuous.

In some implementations, manual input to the actuator 212 may additionally or alternatively control the duration of the momentary switch operation and/or the latching switch operation. For example, energy from the battery 202 may be delivered to the pump 206, via the motor 204, for a period corresponding to a duration of a manual input to the actuator 212 in momentary switch operation. That is, as long as the user applies manual input to the actuator 212 for momentary switch operation, the high-pressure stream of fluid may issue from the nozzle 208. Thus, as a more specific example, the user may apply repeated manual inputs to the actuator 212 in momentary switch operation to achieve a series of bursts of the high-pressure stream of fluid issuing from the nozzle 208. As another example, energy from the battery 202 may be delivered to the pump 206, via the motor 204, continuously until a manual input a manual input is provided to the actuator 212 in latching switch operation. That is, a first manual input to the actuator 212 may initiate operation of the actuator in latching switch operation such that a high-pressure stream of fluid issues from the nozzle 208 until a second manual input (discrete from the first manual input) is provided to the actuator 212 in latching switch operation. As may be appreciated from the foregoing example, by requiring only two discrete manual inputs to the actuator 212, latching switch operation of the actuator 212 may facilitate issuing a high-pressure stream from the nozzle 208 for a long duration while reducing the likelihood of hand strain, as compared to requiring manual input throughout the duration of a long pulse.

While actuation of the actuator 212 may be generally used to start and stop a high-pressure stream from issuing from the nozzle 208 as the user self-administers an oral irrigation treatment, it may be useful to have a limit on the maximum duration of a pulse of the high-pressure stream issuing from the nozzle 208. More specifically, energy from the battery 202 may be delivered to the pump 206, via the motor, until a predetermined motor operation time limit is met in momentary switch operation, latching switch operation, or a combination thereof. Such a time limit may, for example, reduce the likelihood that inadvertent input to the actuator 212 may drain the reservoir 214 of fluid. Further, or instead, such a time limit may facilitate guiding the user to self-administer the oral irrigation treatment according to recommended practices.

In general, the housing 210 may carry the battery 202, the motor 204, the pump 206, the actuator 212 and other associated electronic components while also accommodating the reservoir 214 with a volume holding enough liquid to carry out at least one oral irrigation treatment. That is, within the housing 210, the motor 204, the pump 206, and the battery 202 may be in close proximity to the liquid in the reservoir 214, as is generally useful for maintaining the housing 210 within a size that may be easily grasped and manipulated by most users. Accordingly, to reduce the likelihood that liquid from the reservoir 214 may interfere with the electronics also carried by the housing 210, the housing 210 may define a cavity 240 in which the battery 202, the motor 204, and the pump 206 are disposed, with at least the motor 204 and the battery 202 fluidically isolated (e.g., using one or more seals) from the reservoir 214. Further, or instead, the reservoir 214 may have about the same volume as the cavity 240 (e.g., to within ±15 percent), as may be useful for balancing considerations associated with battery capacity and the size of the reservoir 214.

With respect to the actuator 212, the housing 210 generally transmits a mechanical signal—one indicative of partial depression or full depression of the actuator 212—to a controller 222 within the cavity 240 while also maintaining a liquid-tight seal of the cavity. For example, the actuator 212 may include a first section 251 and a second section 252 mechanically coupled to one another. Continuing with this example, the housing 210 may include a plurality of struts 254 and a hub 256 with the first section 251 of the actuator 212 extending through the hub 256 and into the cavity 240. As an example, the first section 251 of the actuator 212 may be positionable into the cavity 240, via the hub 256, with the motor 204 and the pump 206 disposed in the cavity 240. The plurality of struts 254 may be flexible (e.g., resiliently flexible) in response to changes in pressure (e.g., one or more manual inputs) on the second section 252 of the actuator in a direction into the cavity 240 to selectively switch between momentary switch operation and latching switch operation.

To reduce the likelihood of unintended ingress of liquid into the cavity 240, the housing 210 may include a membrane 258 extending between the plurality of struts 254 and circumscribing the hub 256 through which the first section 251 of the actuator 212 extends. For example, the membrane 258 may be overmolded on the plurality of struts 254 and around the hub 256. In some instances, the membrane 258 is formed of thermoplastic elastomer (TPE) and the plurality of struts 254 may be formed of acrylonitrile butadiene styrene (ABS). The membrane 258 may generally be at least flexible enough to flex along with the plurality of struts 254 in response to changes in pressure on the second section 252 of the actuator in the direction into the cavity 240 such that the membrane 258 may resist liquid ingress into the cavity 240 even as the plurality of struts 254 flex in response to actuation of the actuator 212.

Collectively, the membrane 258, the hub 256, and the first section 251 of the actuator 212 may form a seal fluidically isolating the second section 252 of the actuator 212 from the cavity 240. To facilitate assembling the actuator 212 without disrupting the seal, the second section 252 of the actuator 212 may be securable to the first section 251 of the actuator 212 while the first section 251 of the actuator 212 forms a portion of the seal of the cavity 240. Further, or instead, the first section 251 of the actuator 212 and the second section 252 of the actuator 212 may be adhesively coupled to one another, as may be useful for cost-effective assembly of the actuator 212.

In some implementations, the oral irrigation device 200 may include a shell 260 disposed over at least a portion of the membrane 258. The shell 260 may, for example, define an orifice 262, and the second section 252 of the actuator 212 may be substantially centered in the orifice 262 of the shell 260. As an example, the shell 260 may be adhesively secured to the housing 210, as again may be useful for cost-effective assembly while also reducing the need for forming holes that may interfere with the quality of the seal of the housing 210. The shell 260 may be generally formed of any one or more materials useful for protecting the membrane 258 from puncture or other damage while also being cost-effective and remains aesthetically appealing over repeated use. As an example, the shell may be anodized aluminum.

In some implementations, the housing 210 may be formed of a first material along at least a portion of the reservoir 214 and a second material along at least a portion of the cavity 240, and the first material is secured to the second material along a weld (e.g., an ultrasonic weld) to facilitate fabrication of the housing 210 and/or to provide design flexibility in forming the housing 210 according to user preferences. As an example, the first material along at least a portion of the reservoir 214 may be different from the second material along at least a portion of the cavity 240. As an example, the first material along at least a portion of the reservoir 214 may allow transmission of visible light (e.g., such that a user may visibly see the level of liquid in the reservoir 214 without opening the oral irrigation device 200), and the second material along at least a portion of the cavity 240 may be opaque. Further, or instead, the first material and the second material may facilitate providing different textures, which may be useful for imparting grip to the housing 210 to reduce the likelihood of the housing 210 slipping from the user's hand when the housing 210 becomes wet.

In certain implementations, the oral irrigation device 200 may additionally, or alternatively, include a lid 242 movable between an open position for filling the reservoir 214 and a closed position for maintaining liquid within the reservoir 214. As an example, the lid 242 may be rotatably supported on the housing 210, and the lid 242 may rotate between the open position and the closed position. Further, or instead, in the closed position, the lid 242 may form a seal along a circumference of the reservoir 214 to prevent or resist loss of liquid from the reservoir 214 in the event that the oral irrigation device 200 falls or otherwise becomes inadvertently inverted.

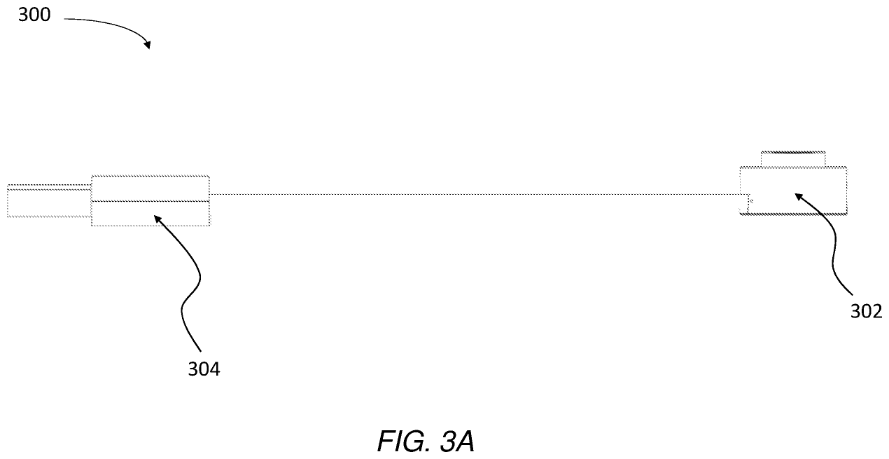

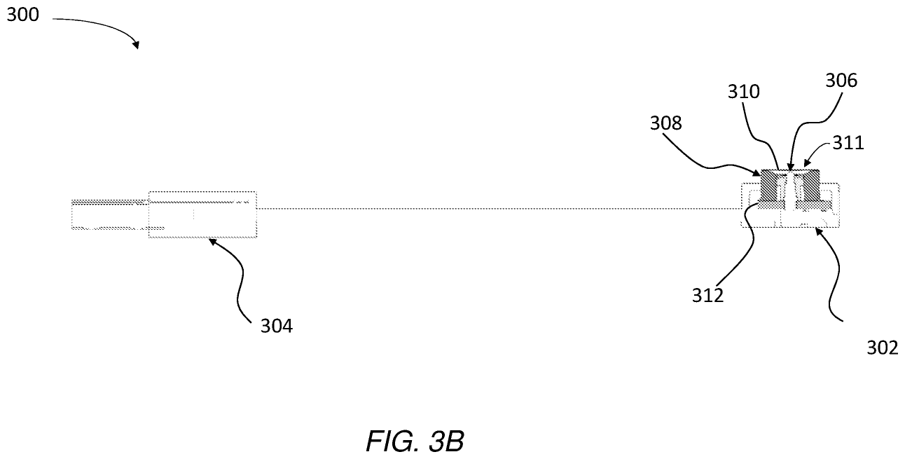

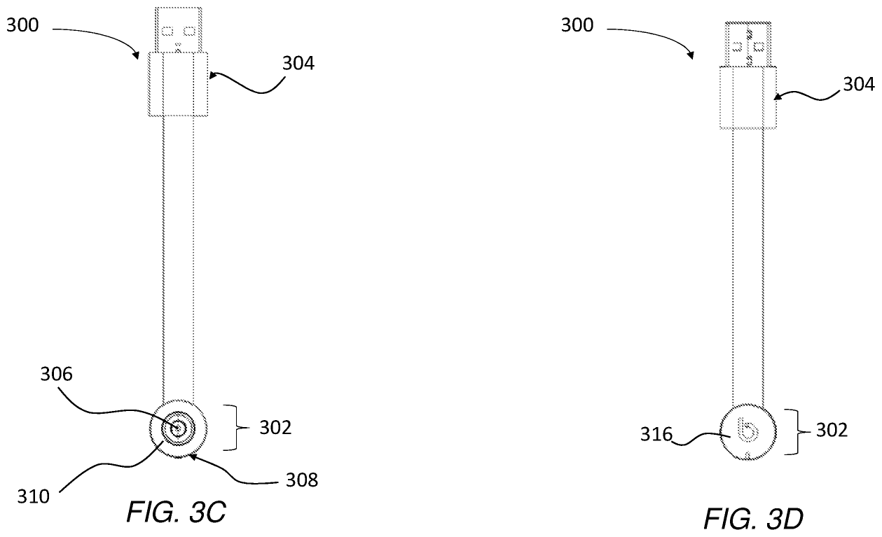

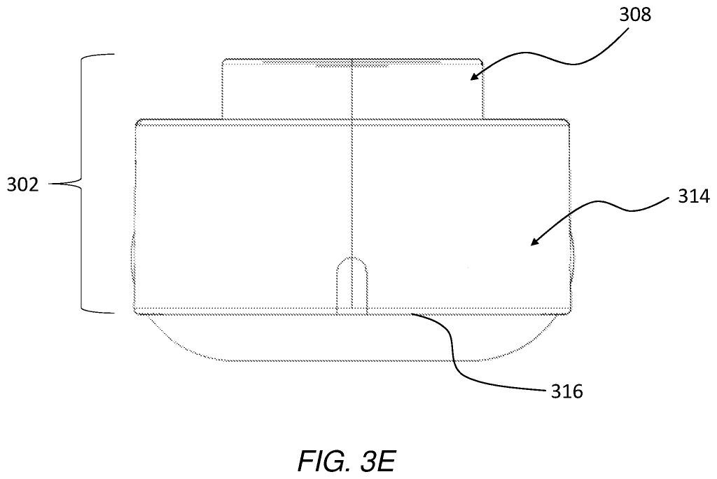

Referring now to FIGS. 2A-2P and 3A-3E, the battery 202 of the oral irrigation device 200 may be periodically recharged using the charger 300. More specifically, the oral irrigation device 200 may include a first contact 271 and a second contact 272 carried on the housing 210 and each in electrical communication with the motor 204 via the battery 202. The charger 300 may include a first connector 302 and a second connector 304 in electrical communication with one another (e.g., via a cable). The first connector 302 may include a pin 306 and a ring 308 and, to charge the battery 202 of the oral irrigation device 200, the oral irrigation device 200 and the first connector 302 may be positioned relative to one another such that the pin 306 moves into contact with the first contact 271 and the ring 308 moves into contact with the second contact 272. Continuing with this example, the second connector 304 may be connected to an external power source such that power from the external power source may be delivered to the battery 202, via the pin 306 and the ring 308 of the first connector 302 in electrical contact with the first contact 271 and the second contact 272, respectively.

In certain implementations, an oral hygiene device 200 may be supportable in a stable orientation on the first connector 302 with the pin 306 touching the first contact 271 and the ring 308 touching the second contact 272 such that the oral hygiene device 200 may be in a stable position during charging. As a more specific example, the oral irrigation device 200 may have a stable orientation on a flat surface (e.g., a bathroom countertop) with the pin 306 touching the first contact 271 and with the ring 308 touching the second contact 272. In each instance, the stable orientation of the oral hygiene device 200 while connected to the first connector 302 may include the nozzle 208 being supported away from the first connector 302 (e.g., by the length of the housing 210 in instances in which the housing 210 is elongate). Thus, among other things, such a stable orientation of the oral irrigation device 200 during charging may reduce the likelihood of the oral irrigation device 200 becoming contaminated during charging and/or may reduce the likelihood of inadvertent disconnection of the oral hygiene device from the charger 300 during charging.

The ring 308 may, for example, have a nonplanar surface 310 to facilitate aligning corresponding contacts on an oral hygiene device (e.g., a corresponding first contact and second contact on the oral irrigation device 200 in FIG. 1). As an example, the nonplanar surface of the ring 308 may define a volume 311, and at least a portion of the pin 306 may extend into the volume 311. Continuing with this example, a portion of a housing of an oral hygiene device may be positionable into the volume 311 to contact a first contact and a second contact of the oral hygiene device to the pin 306 and the ring 308, respectively. As may be appreciated from the foregoing example, the volume 311 of the ring 308 may facilitate coarse alignment of the housing of the oral hygiene device relative to the first connector 302, while alignment of the pin 306 with the first contact of the oral hygiene device facilitates providing fine alignment for reliably establishing an electrical connection that may remain robust in response to jostling. In certain instances, the ring 308 and the second contact of the oral hygiene device may be magnetically connectable to one another, as is useful for transitioning for coarse alignment to fine alignment between the first connector 302 and the oral hygiene device. Further, or instead, the pin 306 and the first contact of the oral hygiene device may be connectable to one another with an interference fit. Among other things, such an interference fit, may be useful for resisting disconnection of the electrical connection of the first connector 302 and the oral hygiene device in instances in which the oral hygiene device, the charger 300, or both are jostled or otherwise moved while the oral hygiene device is being charged.

In certain implementations, the nonplanar surface 310 of the ring 308 may circumscribe the pin 306 such that placement of the oral irrigation device 200 along the nonplanar surface 310 of the ring 308 may facilitate aligning the pin 306 with the first contact 271 of the oral irrigation device 200. As a more specific example, the nonplanar surface 310 of the ring 308 may be continuous about the pin 306 such that the pin 306 and the ring 308 may be connectable, respectively, to the first contact 271 and the second contact 272 of the oral hygiene device 200 independent of the circumferential alignment of the oral irrigation device 200 to the first connector 302 of the charger 300, making connection easier as compared to contacts that are connectable in only one orientation.

While the second connector 304 may be any one or more of various different types of connectors connectable to a power source compatible with charging the battery 202 of the oral irrigation device 200, it shall be appreciated that the second connector 304 may advantageously include a standardized type of connection to facilitate connecting to a ubiquitous power source and, thus, ultimately to promote convenience. As an example, the second connector 304 may be a USB connector, which may be particularly convenient for charging the oral irrigation device during travel, such as in areas in which wall sockets may be difficult to find.

In some implementations, the first connector 302 may include a cover 314 having a flat surface 316, and the pin 306 and the ring 308 may be orientated away from the flat surface 316. Stated differently, the flat surface 316 may be placed on a countertop or other similar surface such that the pin 306 and the ring 308 extend in a direction away from the countertop. Continuing with this example, the oral irrigation device 200 may be lowered onto the first connector 302 to establish an electrical connection between the pin 306 and the ring 308 and the first contact 271 and the second contact 272, respectively, of the oral irrigation device 200. This may, for example, make it easier for a user to establish such an electrical connection using only one hand and/or without complicated manipulations of the charger 300, the oral irrigation device 200, or both.

Additionally, or alternatively, the housing 210 of the oral irrigation device 200 may define a recess 274, as may be useful for connecting the first connector 302 to the first contact 271 and the second contact 272 of the oral irrigation device 200. That is, at least the first connector 302 of the charger 300 may be releasably positionable in the recess 274 to position the pin 306 in contact with the first contact 271 and the ring 308 into contact with the second contact 272.

In certain implementations, the charger 300 may include a fuse 312. As an example, the pin 306 and the ring 308 of the first connector 302 may be in electrical communication with the second connector 304 via the fuse 312. In the event of an anomalous condition resulting in excessive current flow in the circuit that includes the pin 306 and the ring 308 connected to the oral hygiene device, the fuse 312 may react to heat associated with such excessive current flow. As an example, the fuse 312 may be polymeric positive temperature coefficient (PPTC) fuse that changes from a low resistance state to a high resistance state and remains in the high resistance state until the anomalous condition is corrected and/or repaired. That is, in instances in which the fuse 312 is a PPTC fuse, the fuse 312 may return to the low resistance state as current flow returns to normal levels in the circuit. Thus, as compared to a fuse that melts to open a circuit, the fuse 312 including a PPTC fuse does not require replacement following an anomalous condition resulting excessive current condition in the circuit. This may be particularly useful for maintaining the safe operation of the charger 300 without requiring replacement of a fuse.

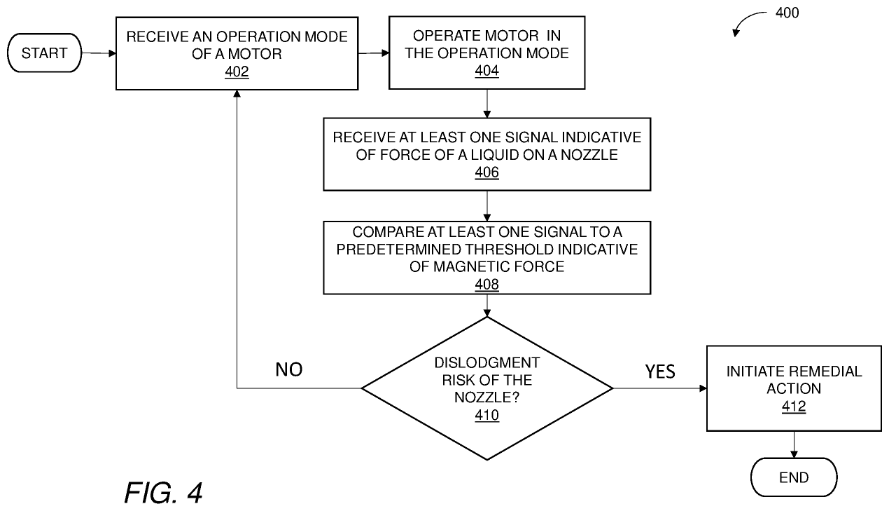

Referring again to FIGS. 2A-2P and FIG. 4, the controller 222 may include one or more processors 224 and a memory 226. The memory 226 may include at least one non-transitory computer-readable storage medium communicatively coupled to the one or more processors 224. The memory 226 may have stored thereon instructions for causing the one or more processors 224 to carry out any one or more of various, different aspects of the exemplary method 400 of controlling the oral irrigation device 200, as shown in FIG. 4.

As shown in step 406, the exemplary method 400 may include receiving at least one signal from a motor mechanically coupled to a pump. The at least one signal may, for example, be indicative of force of a liquid on a nozzle in fluid communication with the pump and insertable into the mouth of a user. As more specific examples, the at least one signal from the motor may include one or more of the following parameters of the motor in operation: voltage, current, impedance, speed, power, or torque.

As shown in step 408 and step 410, the exemplary method 400 may include, based on comparison of the at least one signal to a predetermined threshold indicative of a magnetic force retaining the nozzle in fluid communication with the pump, determining a dislodgment risk condition of the nozzle.

As shown in step 410, the exemplary method 400 may include operating the motor when the dislodgment risk condition is not detected.

As shown in step 410 and step 412, the exemplary method 400 may include initiating a remedial action associated with operation of the motor when the dislodgment risk condition is detected. By way of example and not limitation, the remedial action may include shutting off the motor, providing an alert (e.g., audible and/or visible) to a user, or a combination thereof. As compared to oral irrigation that does not address dislodgment risk, initiating a remedial action in response to detecting a dislodgment risk may reduce the likelihood of inadvertent dislodgment of the nozzle while the high-pressure stream of fluid is being delivered as part of an oral irrigation procedure. This, in turn, may reduce the likelihood of spills or leakage resulting from inadvertent dislodgment of the nozzle.

In certain implementations, as shown in step 402, the exemplary method 400 may additionally or alternatively include receiving an operation mode of the motor based on a manual input from a user (e.g., any one or more of the various different manual inputs described herein). As an example, the manual input from the user may include depressing one or more actuators. In certain instances, the manual input from the user may move an actuator to a first position (e.g., by partially depressing the actuator) to indicate a first operating mode and further, or instead, may move the same actuator to a second position (e.g., by fully depressing the actuator) to indicate a second operating mode, different from the first operating mode. For example, the user may move the actuator to the first position to indicate the first operating mode characterized by short bursts of a high-pressure stream of fluid and additionally, or alternatively, the user may move the actuator to the second position to indicate the second operating mode characterized by a continuous stream of the high-pressure stream of fluid. As may be appreciated from the foregoing example, the user may vary operation of the motor between the first operating mode and the second operating mode through single-handed operation, such as may be useful for self-application of oral irrigation. Unless otherwise specified or made clear from the context, the step 410 may include operating the motor according to the operation mode when the dislodgment risk condition is not detected. Further, or instead, unless otherwise specified or made clear from the context, it shall be understood that the operation mode may include any one or more of the various different operation modes described herein and, thus, may be one of normally-on or normally-off.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims.

What is claimed is:

1. An oral irrigation device comprising:
a battery;
a motor in electrical communication with the battery;
a pump mechanically coupled to the motor;
a nozzle insertable into a mouth of a user;
a housing defining a reservoir, the housing carrying the motor, the pump, the battery, and the nozzle, the nozzle extending in a direction away from the housing, the nozzle in fluid communication with the reservoir via the pump; and
an actuator carried on the housing, the actuator in electrical communication with the battery and the motor, the actuator selectively switchable between momentary switch operation and latching switch operation in delivering energy from the battery to the pump via the motor.

2. The oral irrigation device of claim 1, wherein the actuator is selectively switchable between momentary switch operation and latching switch operation in response to manual input to the actuator.

3. The oral irrigation device of claim 2, wherein the actuator is partially depressible to switch the actuator to momentary switch operation, and the actuator is fully depressible to switch the actuator to latching switch operation.

4. The oral irrigation device of claim 1, wherein energy from the battery is delivered to the pump, via the motor, for a period corresponding to a duration of a manual input to the actuator in momentary switch operation.

5. The oral irrigation device of claim 1, wherein energy from the battery is delivered to the pump, via the motor, continuously until a manual input to the actuator in latching switch operation.

6. The oral irrigation device of claim 1, wherein energy from the battery is delivered to the pump, via the motor, until a predetermined motor operation time limit is met in momentary switch operation, latching switch operation, or a combination thereof.

7. The oral irrigation device of claim 1, wherein the housing is elongate and manually graspable by the user.

8. The oral irrigation device of claim 1, wherein the housing defines a cavity, and the motor, the pump, and the battery are disposed in the cavity with the motor with the battery fluidically isolated from the reservoir.

9. The oral irrigation device of claim 8, wherein the actuator includes a first section and a second section mechanically coupled to one another, the housing includes a plurality of struts and a hub, the plurality of struts supporting the hub along the cavity, the actuator supported on the hub with the first section of the actuator extending through the hub and into the cavity, and the plurality of struts are flexible in response to pressure on the second section of the actuator in a direction into the cavity to selectively switch between momentary switch operation and latching switch operation.

10. The oral irrigation device of claim 9, wherein the housing includes a membrane extending between the plurality of struts and circumscribing the hub.

11. The oral irrigation device of claim 10, wherein the membrane, the hub, and the first section of the actuator collectively forming a seal fluidically isolating the second section of the actuator from the cavity.

12. The oral irrigation device of claim 11, wherein the second section of the actuator is securable to the first section of the actuator while the first section of the actuator forms a portion of the seal.

13. The oral irrigation device of claim 10, further comprising a shell disposed over at least a portion of the membrane, wherein the shell defines an orifice, and the second section of the actuator is substantially centered in the orifice of the shell.

14. The oral irrigation device of claim 9, wherein the first section of the actuator is positionable into the cavity, via the hub, with the motor and the pump disposed in the cavity.

15. The oral irrigation device of claim 1, further comprising a permanent magnet and a collar, wherein the permanent magnet is carried by the housing, the collar is supported on the nozzle, the collar includes at least one ferromagnetic material, and the nozzle is releasably securable to the housing through magnetic force between the permanent magnet and the at least one ferromagnetic material of the collar.

16. The oral irrigation device of claim 15, wherein the permanent magnet is fixed to the housing, the collar is fixed to the nozzle, and the nozzle is rotatable relative to the housing with the nozzle releasably secured to the housing.

17. A nozzle for an oral irrigation device, the nozzle comprising:
a body including a first end portion and a second end portion, the first end portion of the body positionable in a housing of the oral irrigation device with the body releasably secured to the housing of the oral irrigation device and with the second end portion of the body supported away from the housing of the oral irrigation device; and
a filter disposed in fluid communication with the second end portion of the body.

18. The nozzle of claim 17, wherein the first end portion of the body defines a first orifice having a first diameter, the second end portion of the body defines a second orifice having a second diameter less than the first diameter, and the filter is supported along the first end portion of the body.

19. A method of controlling an oral irrigation device, the method comprising:
receiving at least one signal from a motor mechanically coupled to a pump, the at least one signal indicative of force of a liquid on a nozzle in fluid communication with the pump and insertable into the mouth of a user;
based on comparison of the at least one signal to a predetermined threshold indicative of unobstructed operation of the nozzle in fluid communication with the pump, detecting a dislodgment risk condition of the nozzle;
operating the motor when the dislodgment risk condition is not detected; and
initiating a remedial action associated with operation of the motor when the dislodgment risk condition is detected.

20. The method of claim 19, wherein the at least one signal from the motor includes one or more of the following parameters of the motor in operation: voltage, current, impedance, speed, power, or torque.
